(19) United States
(12) Patent Application Publication
(10) Pub. No.: US 2016/0207527 A1
(43) Pub. Date: Jul. 21, 2016

(54) AUTOMATIC DRIVING APPARATUS

(71) Applicant: TOYOTA JIDOSHA KABUSHIKI KAISHA, Toyota-shi, Aichi (JP)

(72) Inventors: Yu HIEI, Susono-shi (JP); Ryuji OKAMURA, Gotenba-shi (JP); Ken KURETAKE, Mishima-shi (JP); Kotaro SAIKI, Susono-shi (JP); Koichiro YAMAUCHI, Nagoya-shi (JP)

(73) Assignee: TOYOTA JIDOSHA KABUSHIKI KAISHA, Toyota-shi, Aichi (JP)

(21) Appl. No.: 14/913,756

(22) PCT Filed: Nov. 11, 2013
(86) PCT No.: PCT/JP2013/080965

§ 371 Date: Feb. 23, 2016

(30) Foreign Application Priority Data
Sep. 4, 2013 (JP) 2013-183032

(51) Int. Cl. B60W 30/06; B60W 10/20; B60W 10/18

(52) U.S. Cl. CPC B60W 30/06; B60W 10/18; B60W 10/20

(57) ABSTRACT

An automatic driving apparatus comprising: a driving mode switching unit that switches a driving mode between an automatic driving mode and a manual driving mode; a first determination unit that determines whether or not a switching operation is performed to switch from the automatic driving mode to the manual driving mode by operation means; and a second determination unit that determines whether or not the driving operation is performed, wherein, in a case where the switching operation is determined to be performed while the vehicle is moving in the automatic driving mode, the driving mode switching unit switches the driving mode to the manual driving mode when the driving operation is determined to be performed and the driving mode switching unit does not switch the driving mode to the manual driving mode when the driving operation is determined not to be performed.

### TECHNICAL FIELD

The present invention relates to an automatic driving apparatus that automatically drives a vehicle.

### BACKGROUND ART

In the related art, for example, in Japanese Unexamined Patent Application Publication No. 10-76965, there is disclosed an automatic driving apparatus that switches a driving mode to a manual steering in response to an operation of a cancellation switch when an abnormality in automatic steering means is detected while an automatic steering is operated.

### CITATION LIST

### Patent Literature

[Patent Literature 1] Japanese Unexamined Patent Application Publication No. 10-76965

[Patent Literature 2] Japanese Unexamined Patent Application Publication No. 2007-331479

### SUMMARY OF INVENTION

### Technical Problem

In such an apparatus, there is a case where a cancellation switch is mistakenly operated when a vehicle is moved by the automatic steering. In this case, there is a problem in that the driving mode is switched to the manual steering contrary to the intention of a driver and thus the driver cannot properly perform a driving operation of the coasting vehicle.

The present invention provides an automatic driving apparatus that can properly switch a driving mode of a vehicle.

### Solution to Problem

An automatic driving apparatus according to the present invention has a driving mode switching unit that switches a driving mode between an automatic driving mode in which a vehicle is driven, braked and steered without relying on a driving operation and a manual driving mode in which the vehicle is driven, braked and steered in response to the driving operation; a first determination unit that determines whether or not a switching operation is performed to switch from the automatic driving mode to the manual driving mode by operation means different from operation means for performing a driving operation related to the driving, braking or steering of the vehicle; and a second determination unit that determines whether or not the driving operation is performed by the operation means for performing a driving operation related to the driving, braking or steering of the vehicle. In a case where the switching operation is determined to be performed while the vehicle is moving in the automatic driving mode, the driving mode switching unit switches the driving mode to the manual driving mode when the driving operation is determined to be performed and the driving mode switching unit does not switch the driving mode to the manual driving mode when the driving operation is determined not to be performed.

According to the present invention, in a case where the driving mode switching operation is determined to be performed while the vehicle is moving in the automatic driving mode, the driving mode is switched to the manual driving mode when the driving operation is determined to be performed and the driving mode is not switched to the manual driving mode when the driving operation is determined not to be performed. Accordingly, even in a case where the driving mode switching operation is mistakenly performed while the vehicle is moving in the automatic driving mode, the driving mode is not switched to the manual driving mode unless the driving operation is performed. That is, when a driver cannot properly perform the driving operation of the vehicle, the driving mode is not switched to the manual driving mode. Therefore, a problem can be suppressed that the driving mode is switched to the manual driving mode contrary to the intention of the driver and thus the driver cannot properly perform the driving operation of the coasting vehicle.

### Advantageous Effects of Invention

The present invention provides an automatic driving apparatus in which the driving mode of a vehicle can be properly switched.

### BRIEF DESCRIPTION OF DRAWINGS

FIG. 1 is a block diagram of a parking assist apparatus according to an embodiment of the present invention.

FIG. 2 is a flow chart of an operation of the parking assist apparatus.

FIG. 3 illustrates an operation of a parking assist apparatus in the related art.

FIG. 4 illustrates the operation of the parking assist apparatus according to the embodiment of the present invention.

### DESCRIPTION OF EMBODIMENT

Hereinafter, an automatic driving apparatus according to an embodiment of the present invention will be described in detail with reference to the accompanying drawings. In the description of the drawings, like numerals are assigned like elements and duplicated descriptions will be omitted.

Hereinafter, a parking assist apparatus mounted on a vehicle to automatically park a vehicle will be described as an example of the automatic driving apparatus that automatically drives the vehicle.

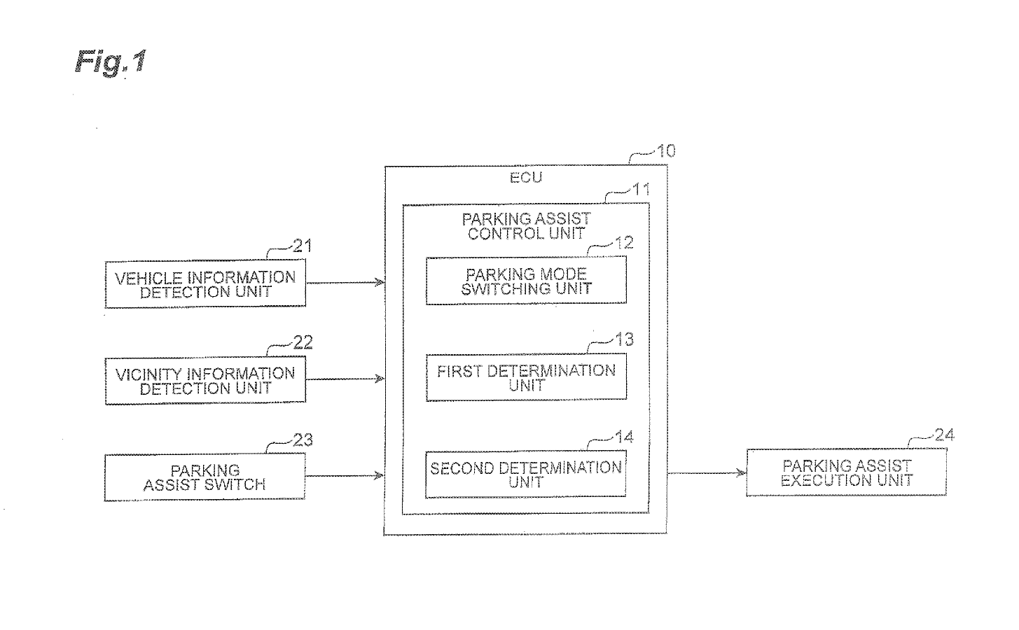

First, a configuration of the parking assist apparatus according to the embodiment of the present invention will be described with reference to FIG. 1. FIG. 1 is a block diagram of the parking assist apparatus according to the embodiment of the present invention. As illustrated in FIG. 1, the parking assist apparatus is configured to be centered around an electronic control unit 10 (hereinafter, referred to as ECU 10) that controls parking assist.

A vehicle information detection unit 21 that detects information on the vehicle is connected to the ECU 10. For example, a wheel speed sensor, a throttle sensor, a brake pedal sensor, a parking brake sensor, a steering sensor and a shift sensor are used as the vehicle information detection unit 21. The vehicle information detection unit 21 sends vehicle information detecting results to the ECU 10.

The wheel speed sensor is a sensor that detects a rotational speed of a vehicle wheel. The throttle sensor is a sensor that detects a throttle opening angle of an engine. The brake pedal sensor is a sensor that detects a travel distance of a brake pedal. The parking brake sensor is a sensor that detects the status of a parking brake operation. The steering sensor is a sensor that detects a steering angle of a steering wheel. The shift sensor is a sensor that detects a shift position selected via a shift lever.

A vicinity information detection unit 22 that detects information on the vicinity of the vehicle is connected to the ECU 10. For example, an image sensor, a laser sensor or a sonar sensor is used as the vicinity information detection unit 22. The vicinity information detection unit 22 detects statuses on front, rear, left and right sides of the vehicle, particularly, the proximity of an object present in the vicinity of the vehicle. The vicinity information detection unit 22 sends vicinity information detecting results to the ECU 10.

A parking assist switch 23 operated to start or end the parking assist is connected to the ECU 10. The parking assist switch 23 is operation means different from operation means for performing a driving operation related to the driving, braking or steering of the vehicle, for example, which is an acceleration pedal, the brake pedal, a parking brake lever (or switch), the steering wheel, the shift lever or the like. For example, a hardware switch arranged on a control panel or the steering wheel, or a software switch displayed on a display is used as the parking assist switch 23. The parking assist switch 23 is arranged at a position in which the parking assist switch 23 can be easily operated by a driver while the vehicle travels.

A parking assist execution unit 24 that executes the parking assist is connected to the ECU 10. For example, the display, a speaker, a vibrator, a throttle actuator, a brake actuator, a steering actuator or a transmission actuator is used as the parking assist execution unit 24. The parking assist execution unit 24 executes the parking assist by assisting the informing and the control of the driving, braking and steering of the vehicle in response to control commands from the ECU 10.

The ECU 10 has a parking assist control unit 11 that controls the parking assist. The parking assist control unit 11 has a parking mode switching unit 12 (driving mode switching unit), a first determination unit 13 and a second determination unit 14. The ECU 10 is configured to have a CPU, a ROM, a RAM, input and output circuits and the like as main parts and to realize a function of the parking assist control unit 11 by executing a program with the CPU. The function of the parking assist control unit 11 may be realized by two or more of the ECUs.

The parking assist control unit 11 controls the parking assist to guide the vehicle to a target parking area. Based on the vicinity information detecting results, the parking assist control unit 11 recognizes one or more candidate parking areas and sets the target parking area and a parking-start area in response to an operation of selecting the candidate parking area. The parking assist control unit 11 generates a guide path from the parking-start area to the target parking area. Based on the vehicle information and the vicinity information, the parking assist control unit 11 controls various types of the actuators to guide the vehicle to the target parking area along the guide path. When it is determined that a difference between a current vehicle position and the target parking area is less than a predetermined threshold value and a vehicle speed is 0 or approximately 0, the parking assist control unit 11 determines that guidance of the vehicle is completed.

Based on a comparison between an arrangement of objects in the vicinity of the vehicle and the dimensions of the vehicle, the candidate parking areas are recognized as one or more areas in which the vehicle can be parked. The target parking area is set to be an area selected by the driver from one or more of the candidate parking areas. The parking-start area is set as an area in which the vehicle is in a stationary state at the time when the target parking area is selected. The guide path is generated as a path by which the vehicle is guided from the parking-start area to the target parking area without interference with objects in the vicinity of the vehicle based on the situation of the objects being arranged.

The parking mode switching unit 12 switches a parking mode between an automatic parking mode in which a vehicle is driven, braked and steered without relying on a driving operation and a manual parking mode in which the vehicle is driven, braked and steered in response to the driving operation. The automatic parking mode is a parking mode with the parking assist, and the manual parking mode is a parking mode without the parking assist.

The first determination unit 13 determines whether or not the parking mode is switched from the automatic parking mode to the manual parking mode via the parking assist switch 23 which is the operation means different from the operation means for performing a driving operation related to the driving, braking or steering. Based on the status of the parking assist switch 23, the first determination unit 13 determines whether or not the parking assist switch 23 is set to be OFF to end the parking assist.

The second determination unit 14 determines whether or not the driving operation is performed by the operation means for performing a driving operation related to the driving, braking or steering. Based on detection results from the throttle sensor, the brake pedal sensor, the steering sensor or a shift lever sensor, particularly, the brake pedal sensor and the steering sensor, the second determination unit 14 determines whether or not the driving operation is performed. When a travel distance of the brake pedal is equal to or greater than a predetermined threshold value of the travel distance; when a steering angle of the steering wheel is equal to or greater than a predetermined threshold value of the steering angle; or when a steering speed is equal to or higher than a predetermined threshold value of the steering speed, the second determination unit 14 determines that the driving operation is performed. When any of the following conditions are met: when the steering angle is equal to or greater than the predetermined threshold value of the steering angle; when the steering speed is equal to or higher than the predetermined threshold value of the steering speed; or when it is determined that the driver grasps the steering wheel based on detection results from a touch sensor provided on the steering wheel, the second determination unit 14 may determine that the driving operation is performed via the operation of the steering wheel.

Herein, in a case where the switching operation is determined to be performed while the vehicle is moving in the automatic parking mode, the parking mode switching unit 12 switches the parking mode to the manual parking mode when the driving operation is determined to be performed and the parking mode switching unit 12 does not switch the parking mode to the manual parking mode when the driving operation is determined not to be performed. Based on the vehicle information detection results and the status of the parking assist switch 23 being operated, the parking mode switching unit 12 determines whether or not the switching operation is performed while the vehicle is moving. The case where the vehicle is moving in the automatic parking mode means the case where the vehicle generates driving forces to be moved by itself.

In addition, in a case where the switching operation is determined to be performed while the vehicle can remain in a stationary state in the automatic parking mode, the parking mode switching unit 12 switches the parking mode to the manual parking mode regardless of whether or not the driving operation is determined to be performed. Based on the vehicle information detection results and the status of the parking assist switch 23 being operated, the parking mode switching unit 12 determines whether or not the switching operation is performed while the vehicle can remain in a stationary state.

Based on the detection results from the parking brake sensor or the shift sensor, the parking mode switching unit 12 determines whether or not the vehicle can remain in a stationary state. When the parking brake is applied, or when a parking position is selected, the parking mode switching unit 12 determines that the vehicle can remain in a stationary state. When the amount of the parking brake lever operation is equal to or greater than a predetermined threshold value, or when the parking brake switch is set to be ON, the parking brake sensor detects the operation of the parking brake.

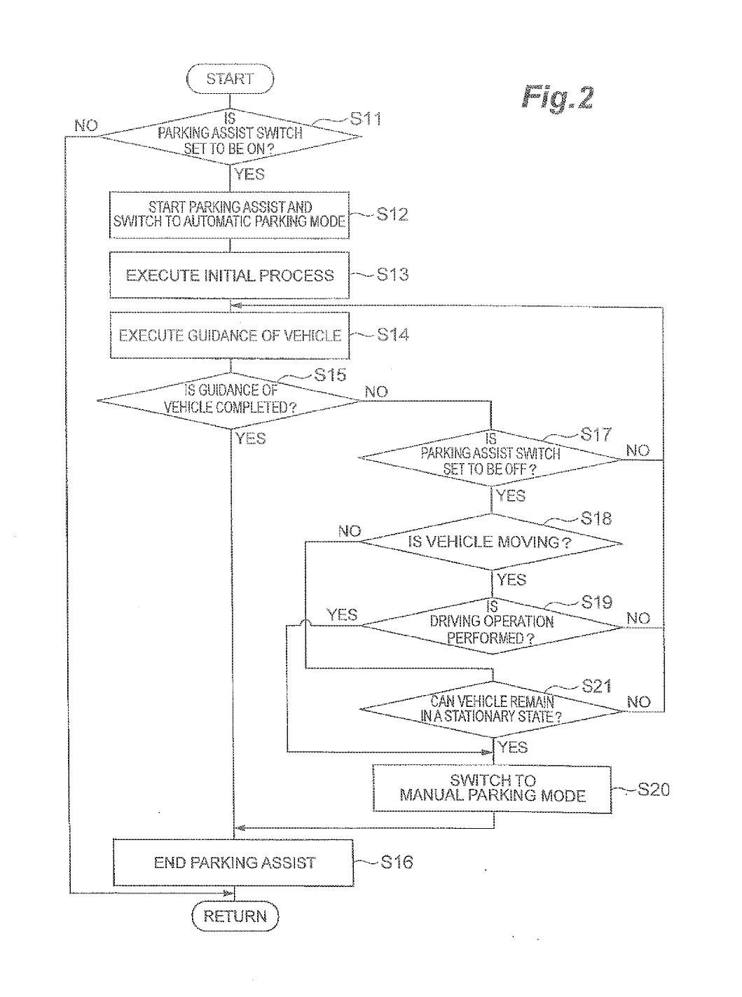

Subsequently, an operation of the parking assist apparatus according to the embodiment of the present invention will be described with reference to FIGS. 2 to 4. FIG. 2 is a flow chart of the operation of the parking assist apparatus. After an engine switch of the vehicle is set to be ON, the parking assist control unit 11 repeatedly executes a process illustrated in FIG. 2 in a predetermined processing period.

The parking assist control unit 11 determines whether or not the parking assist switch 23 is set to be ON to start the parking assist (S11). When it is not determined that the parking assist switch 23 is set to be ON, the process is ended. When it is determined that the parking assist switch 23 is set to be ON at S11, the parking assist control unit 11 starts the parking assist, and the parking mode switching unit 12 switches the parking mode to the automatic parking mode (S12).

When the parking assist is started, the parking assist control unit 11 executes an initial process of the parking assist (S13). First, the parking assist control unit 11 recognizes one or more of the candidate parking areas based on the vicinity information detecting results. Based on a comparison between the situation of objects being arranged in the vicinity of the vehicle and the dimensions of the vehicle, the parking assist control unit 11 recognizes one or more of the areas in which the vehicle can be parked as the candidate parking areas. The parking assist control unit 11 may recognize the candidate parking areas not only while the vehicle is in a stationary state but also while the vehicle travels at low speed.

Subsequently, the parking assist control unit 11 sets the target parking area and the parking-start area in response to an operation of selecting the candidate parking area. The parking assist control unit 11 sets the target parking area as the area selected by the driver from one or more of the candidate parking areas. The driver selects the candidate parking area from one or more of the candidate parking areas appearing on the display while the vehicle is in a stationary state, and thus the target parking area can be selected. The parking assist control unit 11 sets an area in which the vehicle is in a stationary state at the time when the target parking area is selected as the parking-start area.

The parking assist control unit 11 generates the guide path based on the situation of objects arranged in the vicinity of the vehicle. The parking assist control unit 11 generates the guide path as a path by which the vehicle is guided from the parking-start area to the target parking area without interference with the objects in the vicinity of the vehicle.

When the initial process is completed, the parking assist control unit 11 executes the guidance of the vehicle to the target parking area based on the guide path (S14). When the parking assist switch 23 is set to be OFF before the guidance of the vehicle is started, the parking assist control unit 11 can end the parking assist.

Based on the vehicle information and the vicinity information, the parking assist control unit 11 performs feedback controls of various types of the actuators to guide the vehicle along the guide path, and thus the vehicle is guided. That is, the parking assist control unit 11 controls the throttle actuator, the brake actuator and the steering actuator, thereby controlling the driving, braking and steering of the vehicle. In addition, the parking assist control unit 11 controls the transmission actuator, thereby controlling the advance, retreat and gear change of the vehicle. The parking assist control unit 11 may control the parking assist execution unit 24 in such a manner that a target parking position, a current vehicle position and the guide path appear on the display together with the situation of the vicinity of the vehicle.

In regard to the guidance of the vehicle, the parking assist control unit 11 determines whether or not the guidance of the vehicle is completed based on a positional relation between the current vehicle position and the target parking area and the moving status of the vehicle (S15). That is, when it is determined that the difference between the current vehicle position and the target parking area is less than a predetermined threshold value and the vehicle speed is 0 or approximately 0, the parking assist control unit 11 determines that the guidance of the vehicle is completed. When it is determined that the guidance is completed, the parking assist control unit 11 ends the parking assist (S16).

When it is not determined that the parking is completed at S15, the first determination unit 13 determines whether or not the parking assist switch 23 is set to be OFF to end the parking assist (S17). When it is not determined that the parking assist switch 23 is set to be OFF, the process returns to S14 to continue the guidance of the vehicle.

When it is determined that the parking assist switch 23 is set to be OFF at S17, the parking assist control unit 11 determines whether or not the vehicle is moving based on detection results from the wheel speed sensor (S18). When it is not determined that the vehicle is moving, the process proceeds to S21.

When it is determined that the vehicle is moving at S18, the second determination unit 14 determines whether or not the driving operation is performed based on the detection results from the brake pedal sensor and the steering sensor (S19). When it is not determined that the driving operation is performed, the parking mode switching unit 12 does not switch the parking mode to the manual parking mode and the process returns to S14 to continue the guidance of the vehicle.

When it is determined that the driving operation is performed at S19, the parking mode switching unit 12 switches the parking mode to the manual parking mode (S20). The parking assist control unit 11 ends the parking assist (S16).

On the other hand, when it is not determined that the vehicle is moving at S18, the parking assist control unit 11 determines whether or not the vehicle can remain in a stationary state based on the detection results from the parking brake sensor or the shift sensor (S21). When it is not determined that the stationary state can be maintained, the parking mode switching unit 12 does not switch the parking mode to the manual parking mode and the process returns to S14 to continue the guidance of the vehicle.

When it is determined that the stationary state can be maintained at S21, the parking mode switching unit 12 switches the parking mode to the manual parking mode (S20). The parking assist control unit 11 ends the parking assist (S16).

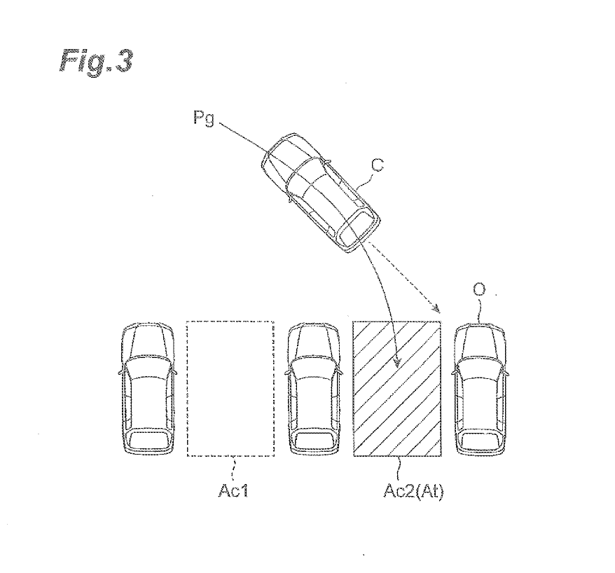

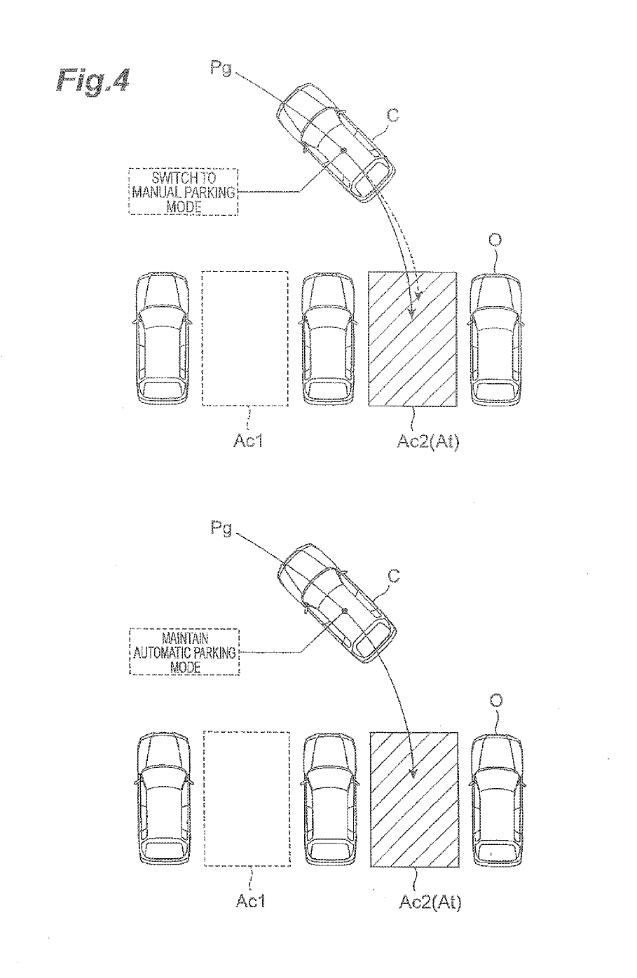

FIG. 3 illustrates an operation of a parking assist apparatus in the related art. FIG. 4 illustrates the operation of the parking assist apparatus according to the embodiment of the present invention. FIGS. 3 and 4 illustrate situations in which the vehicle is guided to a target parking area At selected from two candidate parking areas Ac1 and Ac2 along a guide path Pg. FIGS. 3 and 4 illustrate cases where a vehicle C is parked next to other vehicles, but a parallel parking can also be described in the same way.

As illustrated in FIG. 3, when the parking assist switch 23 is mistakenly set to be OFF while the vehicle C is moving in the automatic parking mode without relying on the driving operation of the driver, there is a problem in that the parking assist apparatus in the related art switches the parking mode to the manual parking mode contrary to the intention of the driver and the driver cannot properly perform the driving operation of the coasting vehicle C (illustrated by a dotted line arrow in FIG. 3). As a result, there is a case in which the coasting vehicle C interferes with an object O in the vicinity of the vehicle C.

On the other hand, as illustrated in the upper drawing of FIG. 4, in a case where the parking assist switch 23 is set to be OFF while the vehicle C is moving in the automatic parking mode, the parking assist apparatus according to the embodiment of the present invention switches the parking mode to the manual parking mode and ends the parking assist when the brake pedal and the steering wheel are operated. In this case, even though the parking mode is switched to the manual parking mode, the driver can brake and steer the vehicle (illustrated by a dotted line arrow in FIG. 4) and thus interference between the coasting vehicle C and the object O can be avoided.

On the other hand, as illustrated in the lower drawing of FIG. 4, in a case where the parking assist switch 23 is set to be OFF while the vehicle C is moving in the automatic parking mode, the parking mode is not switched to the manual parking mode and the parking assist continues when the brake pedal and the steering wheel are not operated. In this case, since the parking mode remains in the automatic parking mode, the driver can be prevented from encountering a situation where the driver cannot avoid interference between the coasting vehicle C and the object O.

Accordingly, even when the parking assist switch 23 is mistakenly set to be OFF while the vehicle is moving in the automatic parking mode, the parking mode is not switched to the manual parking mode unless the driving operation is performed. That is, when the driver cannot properly perform the driving operation of the vehicle, the parking mode is not switched to the manual parking mode. Therefore, a problem can be suppressed that the parking mode is switched to the manual parking mode contrary to the intention of the driver and thus the driver cannot properly perform the driving operation of the coasting vehicle.

In the automatic parking mode, there is a case where the driver applies the parking brake or selects a parking position in such a manner that the vehicle can remain in a stationary state when other vehicles are moved or a pedestrian walks in the vicinity of the vehicle. As such, when the parking assist switch 23 is set to be OFF while the vehicle can remain in a stationary state, the parking mode is switched to the manual parking mode regardless of whether or not the driving operation is performed. The reason is that, even when the parking assist switch 23 is mistakenly set to be OFF, the vehicle can remain in a stationary state and thus the vehicle does not coast.

As described above, in the parking assist apparatus according to the embodiment of the present invention, in a case where the switching operation of the parking mode is determined to be performed while the vehicle is moving in the automatic parking mode, the parking mode is switched to the manual parking mode when the driving operation is determined to be performed and the parking mode is not switched to the manual parking mode when the driving operation is determined not to be performed. That is, when the driver cannot properly perform the driving operation of the vehicle, the parking mode is not switched to the manual parking mode. Accordingly, even in a case where the switching operation of the parking mode is mistakenly performed while the vehicle is moving in the automatic parking mode, the parking mode is not switched to the manual parking mode unless the driving operation is performed. Therefore, the problem can be suppressed that the parking mode is switched to the manual parking mode contrary to the intention of the driver and thus the driver cannot properly perform the driving operation of the coasting vehicle.

The aforementioned embodiment describes an embodiment of the automatic driving apparatus according to the present invention, and the automatic driving apparatus according to the present invention is not limited to the embodiment. The automatic driving apparatus according to the present invention may be modified from the automatic driving apparatus according to the embodiment or may be applied to other embodiments insofar as they are within the scope of the present invention according to each of the appended claims.

For example, in the embodiment, the parking assist apparatus that automatically parks the vehicle has been described as an example of the automatic driving apparatus. However, the present invention is not limited to the case where the vehicle is automatically parked and can be applied in the same way to other cases where the automatic driving is performed.

### REFERENCE SIGNS LIST

10: electronic control unit, 11: parking assist control unit, 12: parking mode switching unit, 13: first determination unit, 14: second determination unit, 21: vehicle information detection unit, 22: vicinity information detection unit, 23: parking assist switch, 24: parking assist execution unit

1. An automatic driving apparatus comprising:
a driving mode switching unit that switches a driving mode between an automatic driving mode in which a vehicle is driven, braked and steered without relying on a driving operation and a manual driving mode in which the vehicle is driven, braked and steered in response to the driving operation;
a first determination unit that determines whether or not a switching operation is performed to switch from the automatic driving mode to the manual driving mode by operation means different from operation means for performing a driving operation related to the driving, braking or steering of the vehicle; and
a second determination unit that determines whether or not the driving operation is performed by the operation means for performing a driving operation related to the driving, braking or steering of the vehicle,
wherein, in a case where the switching operation is determined to be performed while the vehicle is moving in the automatic driving mode, the driving mode switching unit switches the driving mode to the manual driving mode when the driving operation is determined to be performed and the driving mode switching unit does not switch the driving mode to the manual driving mode when the driving operation is determined not to be performed.

2. The automatic driving apparatus according to claim 1,
wherein, in a case where the switching operation is determined to be performed while the vehicle can remain in a stationary state in the automatic driving mode, the driving mode switching unit switches the driving mode to the manual driving mode regardless of whether or not the driving operation is determined to be performed.

3. The automatic driving apparatus according to claim 1,
wherein the automatic driving mode is an automatic parking mode in which the vehicle is driven, braked and steered for parking without relying on the driving operation, and the manual driving mode is a manual parking mode in which the vehicle is driven, braked and steered for the parking in response to the driving operation, and
wherein the second determination unit determines whether or not the driving operation is performed by operation means for performing a driving operation related to the braking and steering of the vehicle.

4. The automatic driving apparatus according to claim 2,
wherein the automatic driving mode is an automatic parking mode in which the vehicle is driven, braked and steered for parking without relying on the driving operation, and the manual driving mode is a manual parking mode in which the vehicle is driven, braked and steered for the parking in response to the driving operation, and
wherein the second determination unit determines whether or not the driving operation is performed by operation means for performing a driving operation related to the braking and steering of the vehicle.
